(19) United States
(12) Patent Application Publication
(10) Pub. No.: US 2025/0099213 A1
(43) Pub. Date: Mar. 27, 2025

(54) Dental floss pick storage box and dental floss dispenser for easy take-out of dental floss picks

(71) Applicant: Songjun DING, Guangzhou (CN)

(72) Inventor: Songjun DING, Guangzhou (CN)

(73) Assignee: Songjun DING, Guangzhou (CN)

(21) Appl. No.: 18/826,248

(22) Filed: Sep. 6, 2024

(30) Foreign Application Priority Data
Sep. 27, 2023 (CN) 202311272456.9

(51) Int. Cl. A61C 15/04

(52) U.S. Cl. CPC A61C 15/043

(57) ABSTRACT

A dental floss pick storage box includes a box body, a guiding structure, and a first interception structure. The box body is provided with a storage chamber and an opening. The guiding structure is connected to the box body, configured to arrange dental floss picks in sequence along an extension direction of the guiding structure, and spaced apart from a side of the box body to form a first avoidance gap. The first interception structure is located on a slide-out path of the dental floss picks, and is movable relative to the box body. When the dental floss pick is taken out from the storage chamber, the dental floss pick slides relative to the box body and approaches the opening until the dental floss pick is supported by the first interception structure, and a part of the dental floss pick reaches out of the storage chamber along the opening.

### CROSS REFERENCE TO THE RELATED APPLICATIONS

This application is based upon and claims priority to Chinese Patent Application No. 202311272456.9, filed on Sep. 27, 2023, the entire contents of which are incorporated herein by reference.

### TECHNICAL FIELD

The present disclosure relates to the technical field of dental floss pick packaging, and in particular to a dental floss pick storage box and a dental floss dispenser for easy taking-out of dental floss picks.

### BACKGROUND

The mainstream dental floss dispenser is a simple flip cover box. A user needs to remove piles of dental floss picks from the dental floss pick bag and load them into the flip cover box. Each time when the user needs to take out the dental floss pick, the user needs to open the cover. Because the opening of the flip cover box is relatively large, sometimes all dental floss picks may fall to the ground due to careless operation of the user. The automatic pop-up dental floss dispenser allows for the take-out of dental floss picks one by one, effectively solving the problem of dental floss picks falling to the ground.

However, the automatic pop-up dental floss dispenser adopts a press-type elastic member, while the press-type elastic member has a complex structure, which greatly increases the cost of the automatic pop-up dental floss dispenser.

### SUMMARY

In order to overcome the shortcomings of the prior art, a first objective of the present disclosure is to provide a dental floss pick storage box, which avoids the unintended incident of dental floss picks falling to the ground when the cover is opened, and reduces the cost.

A second objective of the present disclosure is to provide a dental floss dispenser for easy take-out of dental floss picks, which avoids the unintended incident of dental floss picks falling to the ground when the cover is opened, and reduces the cost.

The first objective of the present disclosure is implemented by the following technical solution.

A dental floss pick storage box includes a box body, a guiding structure, and a first interception structure, where
the box body is provided with a storage chamber; the storage chamber is configured to store dental floss picks; the box body is provided with an opening communicated with the storage chamber; and the opening is configured to allow the dental floss picks to slide out of the storage chamber;
the guiding structure is connected to the box body; the guiding structure is configured to arrange the plurality of dental floss picks in sequence along an extension direction of the guiding structure; the guiding structure is spaced apart from a side of the box body to form a first avoidance gap; and the first avoidance gap is configured to release the dental floss picks from a constraint of the guiding structure;
the first interception structure is located on a slide-out path of the dental floss picks, and is movable relative to the box body to release the dental floss picks intercepted by the first interception structure; and
when the dental floss pick is taken out from the storage chamber, the dental floss pick slides relative to the box body due to gravity and approaches the opening until the dental floss pick is supported by the first interception structure, and a part of the dental floss pick reaches out of the storage chamber along the opening.

Further, the guiding structure includes a first guiding rod; the first guiding rod is connected to the box body; the first guiding rod is spaced apart from the side of the box body to form the first avoidance gap; the first avoidance gap is configured to release the dental floss picks from a constraint of the first guiding rod; the first interception structure is connected to an end of the first guiding rod or the side of the box body, and blocks the first avoidance gap under an action of an elastic restoring force of the first interception structure.

Further, the end of the first guiding rod adjacent to the first interception structure is provided with a first sliding section; the first sliding section is configured to guide and avoid the dental floss pick, such that the dental floss pick slides relative to the box body due to gravity and approaches the opening.

Further, the guiding structure includes a first guiding rod; the first guiding rod is connected to the box body; the first guiding rod is spaced apart from the side of the box body to form the first avoidance gap; the first avoidance gap is configured to release the dental floss picks from a constraint of the first guiding rod; the first interception structure is connected to an end of the first guiding rod or the side of the box body, and extends towards the opening; the first interception structure includes a first avoidance section and a first blocking section connected to the first avoidance section; the first blocking section is closer to the opening than the first avoidance section; and when the dental floss pick is taken out from the storage chamber, the dental floss pick slides relative to the box body due to gravity and approaches the opening until the dental floss pick is supported by the first blocking section of the first interception structure.

Further, the first interception structure is connected to the side of the box body, and the side of the box body is defined as an enclosing side; the enclosing side is further connected to a padding layer; and the padding layer is configured to prevent the dental floss picks from contacting the enclosing side.

Further, the guiding structure further includes a second guiding rod; the second guiding rod is connected to the box body; the second guiding rod is spaced apart from the side of the box body to form a second avoidance gap; and the second avoidance gap is configured to release the dental floss picks from a constraint of the second guiding rod; and
the second avoidance gap is located between the first avoidance gap and the opening; and alternatively, the first avoidance gap is located between the second avoidance gap and the opening.

Further, the first guiding rod is spaced apart from the second guiding rod, and at least one of the first guiding rod and the second guiding rod is nested inside a closed loop of the dental floss pick.

Further, the guiding structure further includes a third guiding rod; the third guiding rod is connected to the box body; the third guiding rod is spaced apart from the side of the box body to form a third avoidance gap; the third avoidance gap is configured to release the dental floss picks from a constraint of the third guiding rod; the dental floss pick storage box further includes a second interception structure; the second interception structure is located on the slide-out path of the dental floss picks, and is movable relative to the box body to release the dental floss picks intercepted by the second interception structure; and
the third avoidance gap is located between the first avoidance gap and the opening.

Further, the second interception structure is connected to an end of the third guiding rod or the side of the box body, and blocks the third avoidance gap under an action of an elastic restoring force of the second interception structure.

Further, the end of the third guiding rod adjacent to the second interception structure is provided with a second sliding section; the second sliding section is configured to guide and avoid the dental floss pick, such that the dental floss pick slides relative to the box body due to gravity and approaches the opening.

Further, the second interception structure is connected to an end of the third guiding rod or the side of the box body, and extends towards the opening; the second interception structure includes a second avoidance section and a second blocking section connected to the second avoidance section; the second blocking section is closer to the opening than the second avoidance section; and when the dental floss pick is taken out from the storage chamber, the dental floss pick slides relative to the box body due to gravity and approaches the opening until the dental floss pick is supported by the second blocking section of the second interception structure.

Further, the dental floss pick storage box further includes a limit plate; the limit plate is located between the first avoidance gap and the opening; and the side of the box body is spaced apart from the limit plate to form the slide-out path for guiding and limiting the dental floss picks.

Further, the first guiding rod is located inside the storage chamber, and/or the second guiding rod is located inside the storage chamber.

Further, a sealing cover is connected at the opening of the box body; the sealing cover is hinged to the box body; the sealing cover is provided with a first clamping groove and a second clamping groove; when the opening is in an opened state, the first clamping groove cooperates with the box body; and when the opening is in a closed state, the second clamping groove cooperates with the box body.

Further, the box body is provided with a clamping portion; and the first clamping groove and the second clamping groove are allowed to be clamped to the clamping portion.

Further, the box body includes a first constituent part and a second constituent part detachably connected to the first constituent part; the storage chamber is located in the first constituent part and covered by the second constituent part; and at least one of the guiding structure and the first interception structure is located at the second constituent part.

Further, a plurality of anti-deformation reinforcement connection elements are connected between the first constituent part and the second constituent part.

Further, the box body includes a filling portion and a filling cover hinged to the filling portion; the filling cover is located at a side in the extension direction of the guiding structure; and the storage chamber is located in the filling portion and covered by the filling cover.

Further, there are at least two openings, at least two guiding structures, and at least two first interception structures; one of the openings corresponds to one of the guiding structures and one of the first interception structures; the slide-out path of the dental floss picks is defined as a first direction, and the extension direction of the guiding structure is defined as a second direction; and two of the openings are respectively located at two opposite sides of the box body in the first direction and at two opposite sides of the box body in the second direction.

The second objective of the present disclosure is implemented by the following technical solution.

A dental floss dispenser for easy take-out of dental floss picks includes a plurality of dental floss picks and the dental floss pick storage box according, where the plurality of dental floss picks are stored in the storage chamber and arranged in sequence in a stacked manner along the extension direction of the guiding structure; and a tip of the dental floss pick is closer to the opening than a closed loop of the dental floss pick.

The above technical solutions have at least the following advantages or beneficial effects.

1. Through the guiding structure, the plurality of dental floss picks are arranged in an orderly manner, which facilitates the user to take out the dental floss picks in an orderly manner and prevents the arrangement of the dental floss picks from being disrupted during transportation. In addition, the guiding structure is spaced apart from one side (i.e. the enclosing side) of the box body to form the first avoidance gap. The first avoidance gap allows the dental floss pick to detach from the constraint of the guiding structure, in order to take out the dental floss pick.

2. The first interception structure is located on the slide-out path of the dental floss pick, and is movable relative to the box body to release the dental floss picks intercepted by the first interception structure. The first interception structure can intercept the target dental floss pick midway, so as to prevent other dental floss picks from falling to the ground due to gravity. In addition, the first interception structure is manually activated to orderly take out the dental floss picks one by one or in small quantities.

3. More importantly, the following effects can be achieved by limiting the overall structure. When the dental floss pick is taken out from the storage chamber, the dental floss pick slides relative to the box body due to gravity and approaches the opening. That is, the dental floss pick moves downward due to gravity to move relative to the box body and approach the opening. In this way, a part of the dental floss pick is exposed (i.e. extended) out of the storage chamber along the opening, and the user can grasp the part of the dental floss pick and pull the dental floss pick out.

4. The dental floss pick storage box utilizes the gravity of the dental floss pick to assist in the take-out process of the dental floss pick, simplifying the overall structure and avoiding complex mechanical transmission component. Therefore, the present disclosure significantly reduces the manufacturing cost of the dental floss pick storage box, lowers or even eliminates the failure rate, and greatly improves the cost-effectiveness of the dental floss pick storage box.

The above summary is for the purpose of the description only and is not intended to be limiting in any way. Further aspects, embodiments, and features of the present disclosure will be readily apparent from reference to the drawings and the following detailed description, in addition to the illustrative aspects, embodiments, and features described above.

### BRIEF DESCRIPTION OF THE DRAWINGS

In the drawings, the same reference numerals refer to like or similar components or elements throughout the multiple drawings unless otherwise specified. The drawings are not necessarily drawn to scale. It should be understood that the drawings depict only some embodiments of the present disclosure and should not be construed as limiting the scope of the present disclosure.

FIG. 1 is a structural diagram of a dental floss dispenser for easy take-out of dental floss picks according to a first embodiment of the present disclosure (the dental floss dispenser for easy take-out of dental floss picks is formed by a dental floss pick storage box, which is provided with a storage chamber for storing the dental floss picks);

FIG. 2 is a structural diagram of the dental floss dispenser for easy take-out of dental floss picks, where an enclosing side and a partial structure shown in FIG. 1 are hidden;

FIG. 3 is a structural diagram of a dental floss dispenser for easy take-out of dental floss picks according to a second embodiment of the present disclosure;

FIG. 4 is a structural diagram of a dental floss dispenser for easy take-out of dental floss picks according to a third embodiment of the present disclosure;

FIG. 5 is a structural diagram of the dental floss dispenser for easy take-out of dental floss picks shown in FIG. 4, where a dental floss pick is taken out of the storage chamber;

FIG. 6 is a structural diagram of a dental floss dispenser for easy take-out of dental floss picks according to a fifth embodiment of the present disclosure;

FIG. 7 is a structural diagram of a dental floss dispenser for easy take-out of dental floss picks according to a ninth embodiment of the present disclosure;

FIG. 8 is a structural diagram of a dental floss dispenser for easy take-out of dental floss picks according to a tenth embodiment of the present disclosure, where an opening is in an opened state;

FIG. 9 is a structural diagram of the dental floss dispenser for easy take-out of dental floss picks shown in FIG. 8, where an opening is in a closed state;

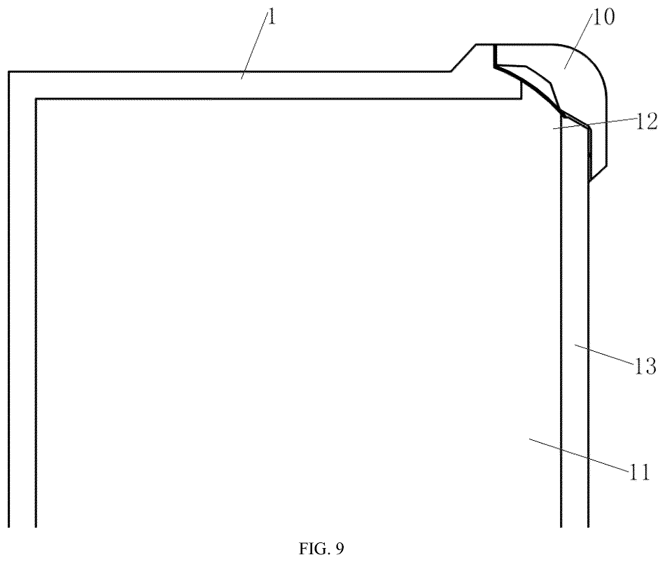

FIG. 10 is a structural diagram of a dental floss dispenser for easy take-out of dental floss picks according to an eleventh embodiment of the present disclosure;

FIG. 11 is a structural diagram of a dental floss dispenser for easy take-out of dental floss picks according to a twelfth embodiment of the present disclosure; and

FIG. 12 is a structural diagram of a dental floss dispenser for easy take-out of dental floss picks according to a thirteenth embodiment of the present disclosure.

Reference Numerals: 1. box body; 11. storage chamber; 12. opening; 13. enclosing side; 14. padding layer; 15. clamping portion; 16. first constituent part; 17. second constituent part; 18. anti-deformation reinforcement connection element; 19. filling portion; 110. filling cover; 2. guiding structure; 21. first guiding rod; 211. first sliding section; 22. second guiding rod; 23. third guiding rod; 231. second sliding section; 3. first interception structure; 31. first avoidance section; 32. first blocking section; 4. dental floss pick; 41. closed loop; 42. tip; 5. first avoidance gap; 6. second avoidance gap; 7. third avoidance gap; 8. second interception structure; 9. limit plate; 10. sealing cover; 101. first clamping groove; and 102. second clamping groove.

### DETAILED DESCRIPTION OF THE EMBODIMENTS

Hereinafter, only certain exemplary embodiments are briefly described. As will be appreciated by those skilled in the art, the described embodiments may be modified in a variety of different ways without departing from the spirit or scope of the present disclosure. Accordingly, the figures and description are considered to be exemplary in nature and not limiting.

### First Embodiment

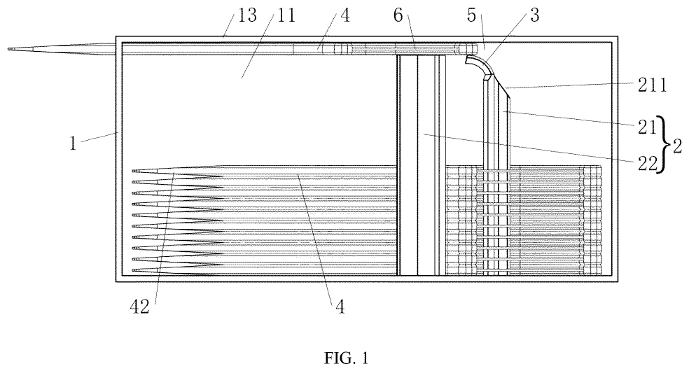

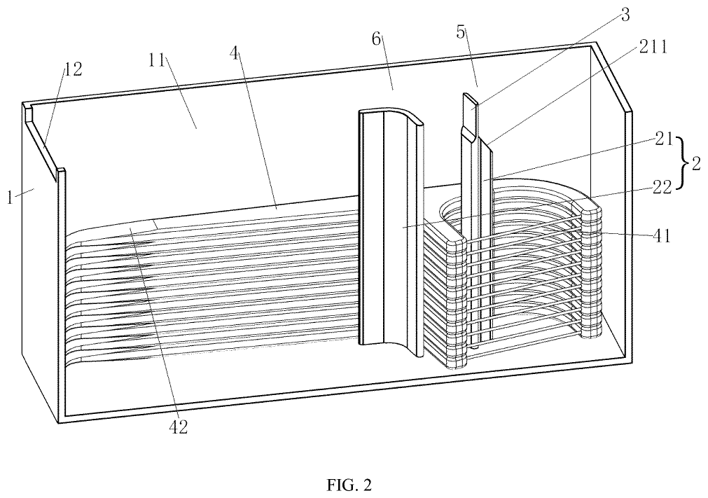

As shown in FIGS. 1 and 2, a dental floss pick storage box includes box body 1, guiding structure 2, and first interception structure 3.

The box body 1 is provided with storage chamber 11. The storage chamber 11 is configured to store dental floss picks 4. The box body 1 is provided with opening 12 communicated with the storage chamber 11. The opening 12 is configured to allow the dental floss picks 4 to slide out of the storage chamber 11. Generally speaking, the dental floss picks 4 can only slide out one by one along the opening 12. Therefore, a thickness of the opening 12 is limited to be greater than or equal to a thickness of the dental floss pick 4, and less than twice the thickness of the dental floss pick 4. However, in an alternative solution, it is sometimes allowed to take out a plurality of dental floss picks 4 once. At this point, the thickness of the opening 12 is appropriately increased, for example, between twice and three times the thickness of the dental floss pick 4.

The guiding structure 2 is connected to the box body 1 (preferably by means of fixed connection, and alternatively by elastic connection). The guiding structure 2 is configured to arrange the plurality of dental floss picks 4 in sequence along an extension direction of the guiding structure 2. The guiding structure 2 is spaced apart from a side of the box body 1 to form first avoidance gap 5 (the side of the box body 1 is configured to enclose the first avoidance gap 5, and is thus defined as enclosing side 13 in this embodiment). The first avoidance gap 5 is configured to release the dental floss picks 4 from a constraint of the guiding structure 2.

The first interception structure 3 is located on a slide-out path of the dental floss picks 4, and is movable relative to the box body 1 (for example, by means of: self-elasticity, manual movement, manual rotation, as well as hinged connection plus a restoring spring) to release the dental floss picks 4 intercepted by the first interception structure 3. In this embodiment, preferably, the first interception structure 3 is movable passively relative to the box body 1. For example, the first interception structure 3 is compressed by the dental floss pick 4 to move, thereby releasing the dental floss pick 4 from the intercepted state.

The core is that when the dental floss pick 4 is taken out from the storage chamber 11, the dental floss pick 4 slides relative to the box body 1 due to gravity and approaches the opening 12 until it is supported by the first interception structure 3, and a part of the dental floss pick 4 extends (i.e., is exposed) out of the storage chamber 11 along the opening 12. The user grasps the part of the dental floss pick 4 (usually tip 42 of the dental floss pick 4, or closed loop 41 of the dental floss pick 4) with fingers. The user pulls the dental floss pick 4, causing the dental floss pick 4 to press against the first interception structure 3 and move, thereby releasing the dental floss pick 4 from the intercepted state. In other words, the movement of the dental floss pick 4 (usually single dental floss pick 4) is released from interference, such that the dental floss picks 4 can be taken out of the storage chamber 11 one by one.

Obviously, through the guiding structure 2, the plurality of dental floss picks 4 are arranged in an orderly manner, which facilitates the user to take out the dental floss picks 4 in an orderly manner and prevents the arrangement of the dental floss picks 4 from being disrupted during transportation. In addition, the guiding structure 2 is spaced apart from one side (i.e. the enclosing side 13) of the box body 1 to form the first avoidance gap 5. The first avoidance gap 5 allows the dental floss pick 4 to detach from the constraint of the guiding structure 2, in order to take out the dental floss pick 4. The first interception structure 3 is located on the slide-out path of the dental floss picks 4, and is movable relative to the box body 1 to release the dental floss picks 4 intercepted by the first interception structure 3. The first interception structure 3 can intercept the target dental floss pick 4 midway, so as to prevent other dental floss picks 4 from falling to the ground due to gravity. In addition, the first interception structure 3 is manually activated to orderly take out the dental floss picks 4 one by one or in small quantities. More importantly, the following effects can be achieved by limiting the overall structure. When the dental floss pick 4 is taken out from the storage chamber 11, the dental floss pick 4 slides relative to the box body 1 due to gravity and approaches the opening 12. That is, the dental floss pick 4 moves downward due to gravity to move relative to the box body 1 and approach the opening 12. In this way, a part of the dental floss pick 4 is exposed (i.e. extended) out of the storage chamber 11 along the opening 12, and the user can grasp the part of the dental floss pick 4 and pull the dental floss pick out. It should also be noted that the dental floss pick storage box utilizes the gravity of the dental floss pick 4 to assist in the take-out process of the dental floss pick 4, simplifying the overall structure and avoiding complex mechanical transmission component. Therefore, the present disclosure significantly reduces the manufacturing cost of the dental floss pick storage box, lowers or even eliminates the failure rate, and greatly improves the cost-effectiveness of the dental floss pick storage box.

In this embodiment, preferably, the guiding structure 2 includes first guiding rod 21. The first guiding rod 21 is connected to the box body 1. Specifically, the first guiding rod 21 of the guiding structure 2 is spaced apart from one side (i.e. the enclosing side 13) of the box body 1 to form the first avoidance gap 5. The first avoidance gap 5 is configured to release the dental floss picks 4 from the constraint of the first guiding rod 21. The first interception structure 3 is connected to an end of the first guiding rod 21 and blocks the first avoidance gap 5 under an action of an elastic restoring force of the first interception structure 3. (In an alternative embodiment, i.e. in the second embodiment, the first interception structure 3 is connected to a side of the box body 1, i.e. the enclosing side 13. For ease of understanding, the design will not be described in detail here, please refer to the second embodiment). In this embodiment, preferably, the first interception structure 3 is made of rubber (especially silicone), polycarbonate (PC), polyethylene (PE), or polypropylene (PP). It can be understood that when the first interception structure 3 is a thin sheet structure, it can also be made of a metal material such as an aluminum sheet, an iron sheet, or a copper sheet. Thus, the first interception structure 3 has an elastic restoring capability. In this way, the first interception structure 3 basically zeros the failure rate until its service life is terminated. This embodiment further makes the following specific limitation. That is, the first interception structure 3 is connected to the end of the first guiding rod 21. Therefore, the first guiding rod 21 is a rigid structure to arrange the plurality of dental floss picks 4 neatly. Besides, the first interception structure 3 is a flexible structure that is movable relative to the box body 1 when the user pulls the dental floss pick 4 to release the dental floss picks 4, and intercepts the next dental floss pick 4 through its own elastic restoration, avoiding subsequent dental floss picks 4 from automatically disengaging from the combination constraints of the guiding structure 2 and the first interception structure 3. In addition, due to the connection of the first interception structure 3 to the end of the first guiding rod 21, the difficulty of manufacturing and assembly processes is reduced.

In this embodiment, preferably, the end of the first guiding rod 21 adjacent to the first interception structure 3 is provided with first sliding section 211. The first sliding section 211 is configured to guide and avoid the dental floss pick 4, such that the dental floss pick 4 slides relative to the box body 1 due to gravity and approaches the opening 12. In this way, when the dental floss pick 4 is taken out from the storage chamber 11 through the first sliding section 211, the dental floss pick 4 slides relative to the box body 1 due to gravity and approaches the opening 12. In addition, the design achieves a simple and practical structure, further reducing the difficulty of manufacturing and assembly processes.

In this embodiment, preferably, the guiding structure 2 further includes second guiding rod 22. The second guiding rod 22 is connected to the box body 1. The second guiding rod 22 is spaced apart from one side (i.e. the enclosing side 13) of the box body 1 to form second avoidance gap 6. The second avoidance gap 6 is configured to release the dental floss picks 4 from the constraint of the second guiding rod 22. In this way, the first guiding rod 21 and the second guiding rod 22 jointly achieve the neat arrangement of the plurality of dental floss picks 4, and avoid adjacent dental floss picks 4 from acting disorderly. Therefore, the plurality of dental floss picks 4 in the storage chamber 11 are always arranged in an orderly manner for subsequent take-out one by one. It can be understood that the second avoidance gap 6 and the first avoidance gap 5 have the same function.

More preferably, the second avoidance gap 6 is located between the first avoidance gap 5 and the opening 12. The design meets the requirement of the dental floss pick 4 with a long strip structure. Moreover, due to the absence of an interception element on the second guiding rod 22, the second guiding rod is located between the first avoidance gap 5 and the opening 12. In other words, it is limited that, only the dental floss pick 4 that passes through the first interception structure 3 has more spatial degrees of freedom. That is to say, in an alternative solution, the first avoidance gap 5 can also be located between the second avoidance gap 6 and the opening 12. However, there is a significant drawback in this case, that is, a part of the dental floss pick 4 (assuming the closed loop 41) can slide out along the first avoidance gap 5, resulting in disorder among the plurality of dental floss picks 4 in the storage chamber 11. In addition, in another alternative solution, the first avoidance gap 5 and the second avoidance gap 6 are arranged flush, that is, the first avoidance gap and the second avoidance gap are equally distant from the opening 12.

In this embodiment, preferably, the first guiding rod 21 is spaced apart from the second guiding rod 22, and at least one of the first guiding rod 21 and the second guiding rod 22 is nested inside the closed loop 41 of the dental floss pick 4. That is to say, the closed loop 41 of the dental floss pick 4 is sleeved outside the first guiding rod 21 and/or the second guiding rod 22, thereby reliably avoiding disorder between the plurality of dental floss picks 4. Additionally, it should be noted that this design utilizes the mature structure of the existing dental floss pick 4. Regarding the structural design of future dental floss picks 4, the dental floss pick 4 can also be provided with positioning holes extending along a thickness direction of the dental floss pick 4, and the positioning hole cooperate with the first guiding rod 21 or the second guiding rod 22. When there are two or more positioning holes, one of the positioning holes cooperates with the first guiding rod 21, and the other positioning hole cooperates with the second guiding rod 22.

In this embodiment, preferably, the first guiding rod 21 is located inside the storage chamber 11, and/or the second guiding rod 22 is located inside the storage chamber 11. It should be noted that the storage chamber 11 is configured to store the plurality of dental floss picks 4, but it is not required that all parts of the dental floss pick 4 be located in the storage chamber 11 to avoid air pollution of the dental floss pick 4. However, in this embodiment, it is always limited that, when the dental floss pick 4 is taken out, the dental floss pick is taken out along the opening 12. That is to say, in an alternative solution, the box body 1 is provided with a hollow portion, such that a part of the dental floss pick 4 is exposed outside the storage chamber 11. However, the hollow portion may not provide much or even no assistance in taking out the dental floss pick 4, and therefore does not affect the following core idea. That is, when the dental floss pick 4 is taken out from the storage chamber 11, the dental floss pick 4 slides relative to the box body 1 due to gravity and approaches the opening 12 until it is supported by the first interception structure 3, such that a part of the dental floss pick 4 reaches out of the storage chamber 11 along the opening 12.

The present disclosure further provides a dental floss dispenser for easy take-out of dental floss picks, including a plurality of dental floss picks 4 and the dental floss pick storage box. The plurality of dental floss picks 4 are stored in the storage chamber 11 and arranged in sequence in a stacked manner along the extension direction of the guiding structure 2. The tip 42 of the dental floss pick 4 is closer to the opening 12 than the closed loop 41 of the dental floss pick 4. The design utilizes the structure of the existing dental floss pick 4 to guide and constrain the dental floss pick 4, in order to arrange the plurality of dental floss picks 4 neatly in the storage chamber 11. Moreover, the tip 42 of the dental floss pick 4 is first exposed (i.e. extended) out of the storage chamber 11 along the opening 12 for the user to grasp by hand, so as to avoid contamination of the closed loop 41 of the dental floss pick 4 by human hands and ensure the cleanliness of the dental floss pick 4.

### Second Embodiment

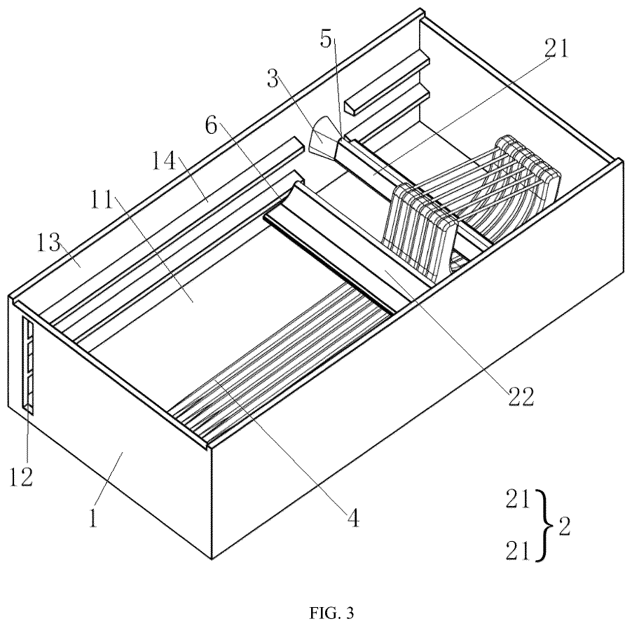

Referring to FIG. 3, the second embodiment includes the first embodiment, which differs from the first embodiment in the following aspects.

In this embodiment, preferably, the guiding structure 2 includes first guiding rod 21. The first guiding rod 21 is connected to the box body 1. The first guiding rod 21 is spaced apart from one side (i.e. the enclosing side 13) of the box body 1 to form the first avoidance gap 5. The first avoidance gap 5 is configured to release the dental floss picks 4 from the constraint of the first guiding rod 21. The first interception structure 3 is connected to one side (i.e. the enclosing side 13) of the box body 1 and blocks the first avoidance gap 5 under an action of an elastic restoring force of the first interception structure 3. Therefore, this embodiment mainly changes the position and connection relationship of the first interception structure 3. In this way, the first interception structure 3 is connected to the enclosing side 13, enhancing the connection strength of the first interception structure 3. Therefore, the first interception structure 3 is not easily detached, greatly increasing the maximum number of pulling times of the first interception structure and extending its service life.

In this embodiment, the first interception structure 3 is connected to a side of the box body 1 (i.e. the enclosing side 13). Further preferably, the enclosing side 13 is further connected to padding layer 14. The padding layer 14 is configured to prevent the dental floss picks 4 from contacting the enclosing side 13. It should be noted that the first interception structure 3 is connected to the enclosing side 13 (for example, by means of bendable connection, elastic connection, adhesive connection, etc.), and the first interception structure 3 is always connected to the enclosing side 13. Therefore, an openable channel (in this embodiment, the first avoidance gap 5) is provided only between the first interception structure 3 and the first guiding rod 21 for the dental floss pick 4 to break free from the constraint of the first guiding rod 21 and the interception of the first interception structure 3. If the dental floss pick 4 is too close or even in contact with the enclosing side 13, it may not be able to smoothly slide out along the openable channel (in this embodiment, the first avoidance gap 5). The padding layer 14 is in contact with the dental floss pick 4 to prevent the dental floss pick 4 from coming into contact with the enclosing side 13, thereby restricting the dental floss pick 4 at a corresponding position of the openable channel (in this embodiment, the first avoidance gap 5) for smooth taken-out of the dental floss pick 4.

### Third Embodiment

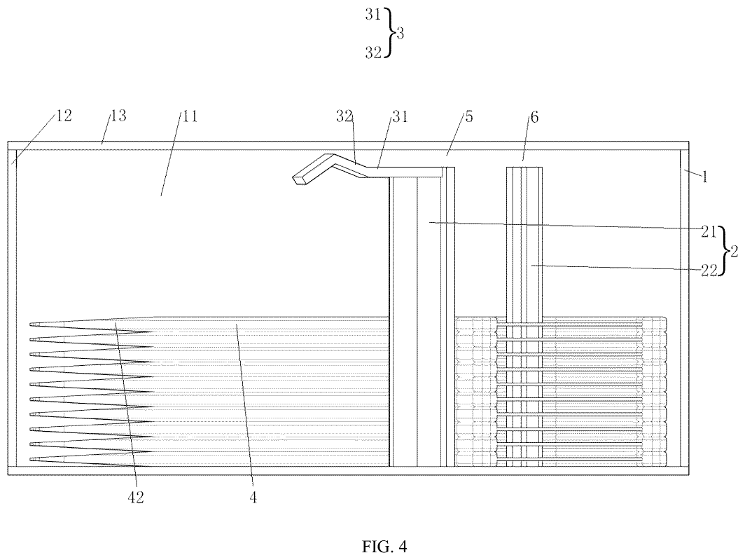

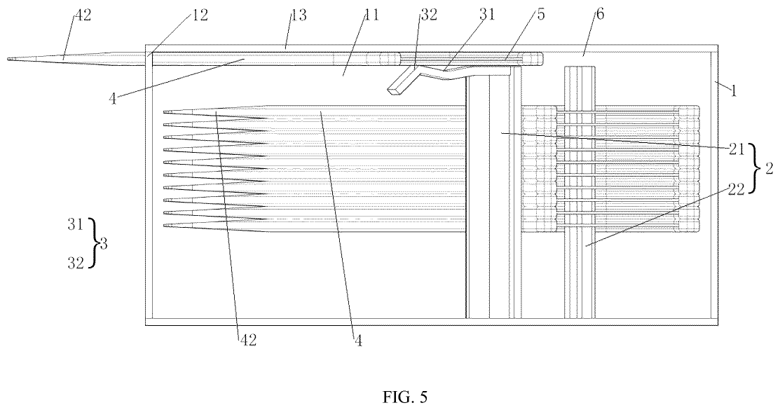

Referring to FIGS. 4 and 5, the third embodiment includes the second embodiment, which differs from the second embodiment in the following aspects.

In this embodiment, preferably, the guiding structure 2 includes first guiding rod 21. The first guiding rod 21 is connected to the box body 1. The first guiding rod 21 is spaced apart from one side (i.e. the enclosing side 13) of the box body 1 to form the first avoidance gap 5. The first avoidance gap 5 is configured to release the dental floss picks 4 from the constraint of the first guiding rod 21. The first interception structure 3 is connected to an end of the first guiding rod 21 and extends towards the opening 12. (In an alternative embodiment, i.e. in the fourth embodiment, the first interception structure 3 is connected to one side (i.e. the enclosing side 13) of the box body 1. For ease of understanding, the design will not be described in detail here, please refer to the fourth embodiment). In this implementation, the first interception structure 3 includes first avoidance section 31 and first blocking section 32 connected to the first avoidance section 31. The first blocking section 32 is closer to the opening 12 than the first avoidance section 31. When the dental floss pick 4 is taken out from the storage chamber 11, the dental floss pick 4 slides relative to the box body 1 due to gravity and approaches the opening 12 until it is supported by the first blocking section 32 of the first interception structure 3. This embodiment mainly makes changes to the position and structure of the first interception structure 3. The first avoidance section 31 is configured to avoid the dental floss pick 4 to be taken out, such that the dental floss pick 4 slides down the first avoidance gap 5 due to gravity until it is supported by the first blocking section 32. This stroke depends on the length of the first avoidance section 31, providing the function of adjusting the length of the dental floss pick 4 reaching out of the storage chamber 11 over a wide range. The function is set according to actual product requirements, suitable for various sizes of dental floss picks 4.

In addition, in this embodiment, the first avoidance gap 5 is located between the second avoidance gap 6 and the opening 12. During the process of taking out the dental floss pick 4, when the dental floss pick 4 is supported by the first blocking section 32, the tip 42 is completely located outside the storage chamber 11, such that the user can easily grasp the dental floss pick 4.

### Fourth Embodiment (Not Shown in the Figure)

The fourth embodiment includes the third embodiment, which differs from the third embodiment in the following aspects.

In this embodiment, preferably, the guiding structure 2 includes first guiding rod 21. The first guiding rod 21 is connected to the box body 1. The first guiding rod 21 is spaced apart from one side (i.e. the enclosing side 13) of the box body 1 to form the first avoidance gap 5. The first avoidance gap 5 is configured to release the dental floss picks 4 from the constraint of the first guiding rod 21. The first interception structure 3 is connected to one side (i.e. the enclosing side 13) of the box body 1 and extends towards the opening 12. The first interception structure 3 includes first avoidance section 31 and first blocking section 32 connected to the first avoidance section 31. The first blocking section 32 is closer to the opening 12 than the first avoidance section 31. When the dental floss pick 4 is taken out from the storage chamber 11, the dental floss pick 4 slides relative to the box body 1 due to gravity and approaches the opening 12 until it is supported by the first blocking section 32 of the first interception structure 3. Therefore, this embodiment mainly changes the connection relationship of the first interception structure 3. Optimally, the end of the first guiding rod 21 adjacent to the enclosing side 13 is provided with a wide surface structure, which, together with the first interception structure 3, achieves the interception of the dental floss pick 4. In an alternative solution, the first interception structure 3 is provided with a closable first one-way through-hole (similar to a one-way valve), through which the dental floss pick 4 passes downwards to enter the slide-out path.

### Fifth Embodiment

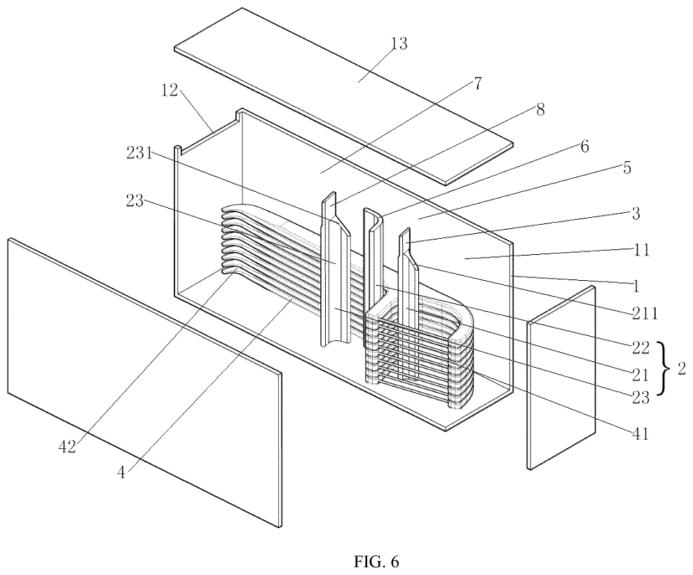

Referring to FIG. 6, the fifth embodiment includes the first embodiment, which differs from the first embodiment in the following aspects.

In this embodiment, preferably, the guiding structure 2 further includes third guiding rod 23. The third guiding rod 23 is connected to the box body 1. The third guiding rod 23 is spaced apart from one side (i.e. the enclosing side 13) of the box body 1 to form third avoidance gap 7. The third avoidance gap 7 is configured to release the dental floss picks 4 from the constraint of the third guiding rod 23. The dental floss pick storage box further includes second interception structure 8. The second interception structure 8 is located on the slide-out path of the dental floss picks 4, and is movable relative to the box body 1 to release the dental floss picks 4 intercepted by the second interception structure 8. This embodiment mainly adds the third guiding rod 23. Specifically, in the best layout structure, the first guiding rod 21, the second guiding rod 22, and the third guiding rod 23 are arranged in sequence along the slide-out path of the dental floss picks 4. The design utilizes the third guiding rod 23 to further guide and constrain the dental floss pick 4. The dental floss pick 4 can only be completely taken out after passing through the first interception structure 3 and the second interception structure 8 in sequence. On the one hand, the design prevents an unintended incident, that is, the dental floss picks 4 all fall to the ground due to an error in the first interception structure 3. On the other hand, the plurality of (theoretically all) dental floss picks 4 inside the storage chamber 11 are arranged neatly, hard to be disordered.

More preferably, the third avoidance gap 7 is located between the first avoidance gap 5 and the opening 12. The design meets the requirement of the dental floss pick 4 with a long strip structure. In another alternative solution, the first avoidance gap 5 and the third avoidance gap 7 are arranged flush, that is, the first avoidance gap and the third avoidance gap are equally distant from the opening 12. In this embodiment, preferably, the second interception structure 8 is connected to an end of the third guiding rod 23 and blocks the third avoidance gap 7 under an action of an elastic restoring force of the second interception structure 8. (In an alternative embodiment, i.e. in the sixth embodiment, the second interception structure 8 is connected to one side (i.e. the enclosing side 13) of the box body 1. For ease of understanding, the design will not be described in detail here, please refer to the sixth embodiment). In this embodiment, it can be understood that, similar to the first interception structure 3, the second interception structure 8 is made of rubber (especially silicone), PC, PE, or PP. It can be understood that when the first interception structure 3 is a thin sheet structure, it can also be made of a metal material such as an aluminum sheet, an iron sheet, or a copper sheet. Thus, the first interception structure 3 has an elastic restoring capability. The design principle and effect of the second interception structure 8 can fully refer to the first interception structure 3 (i.e. refer to the first embodiment).

In this embodiment, preferably, the end of the third guiding rod 23 adjacent to the second interception structure 8 is provided with second sliding section 231. The second sliding section 231 is configured to guide and avoid the dental floss pick 4, such that the dental floss pick 4 slides relative to the box body 1 due to gravity and approaches the opening 12. It can be understood that the design and effect of the second sliding section 231 can fully refer to the first sliding section 211 (i.e., refer to the first embodiment). In this way, when the dental floss pick 4 is taken out from the storage chamber 11 through the second sliding section 231, the dental floss pick 4 slides relative to the box body 1 due to gravity and approaches the opening 12. In addition, the design achieves a simple and practical structure, further reducing the difficulty of manufacturing and assembly processes.

### Sixth Embodiment (Not Shown in the Figure)

The sixth embodiment includes the fifth embodiment, which differs from the fifth embodiment in the following aspects.

In this embodiment, preferably, the second interception structure 8 is connected to one side (i.e. the enclosing side 13) of the box body 1 and blocks the third avoidance gap 7 under an action of an elastic restoring force of the second interception structure 8. The second interception structure in this embodiment is designed in the same way as the first interception structure 3 in the first embodiment. That is to say, this embodiment mainly changes the position and connection relationship of the second interception structure 8. In this way, the second interception structure 8 is connected to the enclosing side 13, enhancing the connection strength of the second interception structure 8. Therefore, the second interception structure 8 is not easily detached, greatly increasing the maximum number of pulling times of the second interception structure and extending its service life.

### Seventh Embodiment (Not Shown in the Figure)

The seventh embodiment includes the fifth embodiment, which differs from the fifth embodiment in the following aspects.

In this embodiment, preferably, the second interception structure 8 is connected to an end of the third guiding rod 23 and extends towards the opening 12. (In an alternative embodiment, i.e. in the eighth embodiment, the second interception structure 8 is connected to one side (i.e. the enclosing side 13) of the box body 1. For ease of understanding, the design will not be described in detail here, please refer to the eighth embodiment). In this embodiment, the second interception structure 8 includes a second avoidance section and a second blocking section connected to the second avoidance section. The second blocking section is closer to the opening 12 than the second avoidance section. When the dental floss pick 4 is taken out from the storage chamber 11, the dental floss pick 4 slides relative to the box body 1 due to gravity and approaches the opening 12 until it is supported by the second blocking section of the second interception structure 8. The second interception structure in this embodiment is designed in the same way as the first interception structure 3 in the third embodiment. That is to say, this embodiment mainly makes changes to the position and structure of the second interception structure 8. The second avoidance section is configured to avoid the dental floss pick 4 to be taken out, such that the dental floss pick 4 slides down the third avoidance gap 7 due to gravity until it is supported by the second blocking section. This stroke depends on the length of the second avoidance section, providing the function of adjusting the length of the dental floss pick 4 reaching out of the storage chamber 11 over a wide range. The function is set according to actual product requirements, suitable for various sizes of dental floss picks 4.

### Eighth Embodiment (Not Shown in the Figure)

The eighth embodiment includes the seventh embodiment, which differs from the seventh embodiment in the following aspects.

In this embodiment, preferably, the second interception structure 8 is connected to one side (i.e. the enclosing side 13) of the box body 1 and extends towards the opening 12. The second interception structure 8 includes a second avoidance section and a second blocking section connected to the second avoidance section. The second blocking section is closer to the opening 12 than the second avoidance section. When the dental floss pick 4 is taken out from the storage chamber 11, the dental floss pick 4 slides relative to the box body 1 due to gravity and approaches the opening 12 until it is supported by the second blocking section of the second interception structure 8. The second interception structure in this embodiment is designed in the same way as the first interception structure 3 in the fourth embodiment. That is to say, this embodiment mainly changes the connection relationship of the second interception structure 8. Optimally, the end of the third guiding rod 23 adjacent to the enclosing side 13 is provided with a wide surface structure, which, together with the second interception structure 8, achieves the interception of the dental floss pick 4. In an alternative solution, the second interception structure 8 is provided with a closable second one-way through-hole (similar to a one-way valve), through which the dental floss pick 4 passes downwards to enter the slide-out path.

### Ninth Embodiment

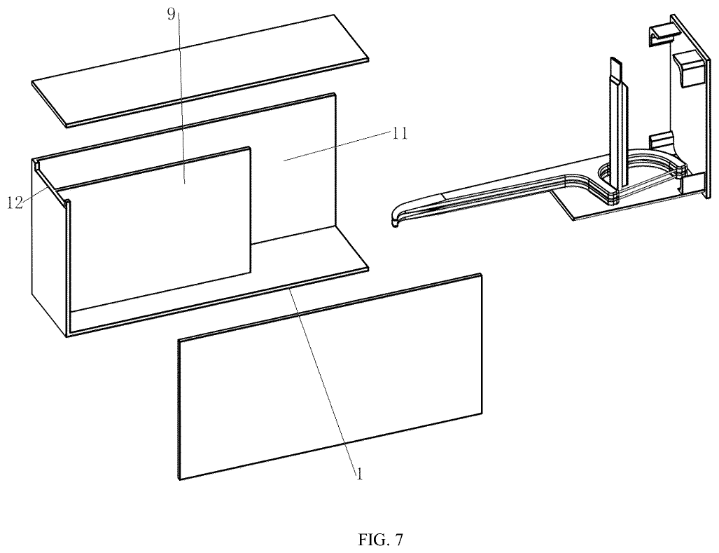

Referring to FIG. 7 (for ease of understanding, please further refer to FIG. 1 or 6), the ninth embodiment includes the first embodiment, which differs from the first embodiment in the following aspects.

In this embodiment, preferably, the dental floss pick storage box further includes limit plate 9. The limit plate 9 is located between the first avoidance gap 5 and the opening 12. A side of the box body 1 (i.e. the enclosing side 13) is spaced apart from the limit plate 9 to form a slide-out path for guiding and limiting the dental floss picks 4. This embodiment mainly adds the limit plate 9, such that after coming into contact with the limit plate 9 on the slide-out path, the dental floss pick 4 is firmly restricted on the narrow slide-out path until it reaches the opening 12. In this way, the dental floss picks 4 are taken out efficiently and accurately.

### Tenth Embodiment

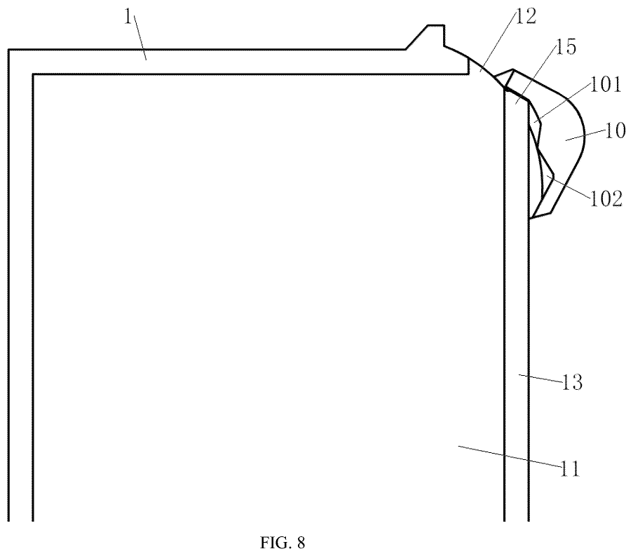

Referring to FIG. 8, the tenth embodiment includes the first embodiment, which differs from the first embodiment in the following aspects.

In this embodiment, preferably, sealing cover 10 is connected at the opening 12 of the box body 1. The sealing cover 10 is hinged to the box body 1 and is able to swing relative to the box body 1. The sealing cover 10 is provided with first clamping groove 101 and second clamping groove 102. When the opening 12 is in an opened state, the first clamping groove 101 cooperates with the box body 1. When the opening 12 is in a closed state, the second clamping groove 102 cooperates with the box body 1. The sealing cover 10 is configured to cover the opening 12 to achieve dust-proof, waterproof and other purposes. In an alternative solution, magnetic fixation can be adopted. That is, a first magnet is connected to the sealing cover 10, and a second magnet (or a magnetic attraction piece) is connected to the opening 12 of the box body 1.

In this embodiment, more preferably, the box body 1 is provided with clamping portion 15. The first clamping groove 101 and the second clamping groove 102 are allowed to be clamped to the clamping portion 15. In this way, after the sealing cover 10 is opened, the position of the sealing cover is fixed, making it easy to continuously take out a plurality of dental floss picks 4 in sequence without the need for the user to hold the sealing cover 10 continuously.

### Eleventh Embodiment

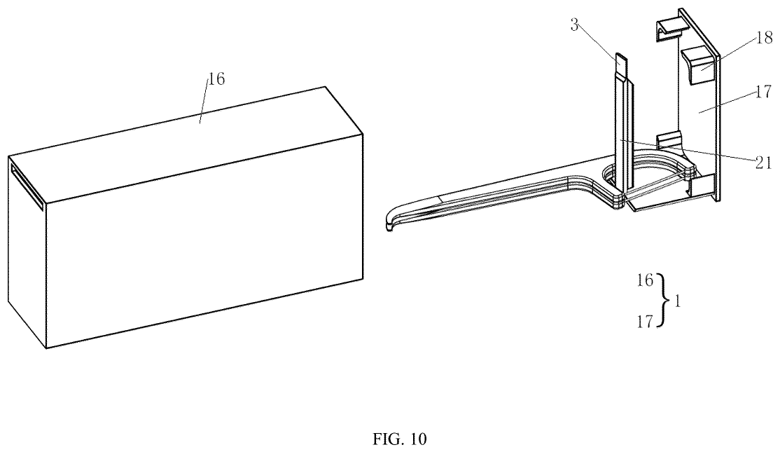

Referring to FIG. 10, the eleventh embodiment includes the first embodiment, which differs from the first embodiment in the following aspects.

In this embodiment, preferably, the box body 1 includes first constituent part 16 and second constituent part 17 detachably connected to (e.g. inserted into) the first constituent part 16. The storage chamber 11 is located in the first constituent part 16 and covered by the second constituent part 17. At least one of the guiding structure 2 and the first interception structure 3 is located at the second constituent part 17. When a new dental floss pick 4 is filled, the second constituent part 17 is pulled out from the first constituent part 16 to fill the new dental floss pick 4, and finally the second constituent part is inserted back into the first constituent part 16. It should be noted that after the second constituent part 17 is pulled out, at least one of the guiding structure 2 and the first interception structure 3 is located at the second constituent part 17, thereby improving the convenience of filling the dental floss pick 4.

In this embodiment, more preferably, a plurality of anti-deformation reinforcement connection elements 18 are connected between the first constituent part 16 and the second constituent part 17. The design improves the overall strength of the box body 1 to prevent plastic deformation of the box body.

### Twelfth Embodiment

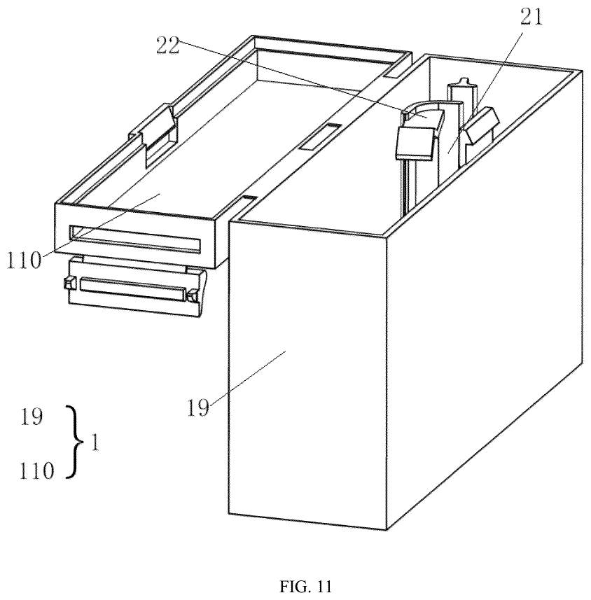

Referring to FIG. 11, the twelfth embodiment includes the eleventh embodiment, which differs from the eleventh embodiment in the following aspects.

In this embodiment, preferably, the box body 1 includes filling portion 19 and filling cover 110 hinged to the filling portion 19. The filling cover 110 is located at a side in the extension direction of the guiding structure 2 (such as a top of the guiding structure 2 in this embodiment). The storage chamber 11 is located in the filling portion 19 and covered by the filling cover 110. In this way, the storage chamber 11 is exposed to the outside simply by flipping the filling cover 110. Moreover, as the filling cover 110 is located at the side in the extension direction of the guiding structure 2, the length direction of the guiding structure 2 is projected into a dot shape, which facilitates the stacking of the dental floss picks 4 onto the guiding structure 2.

Additionally, it should be noted that in this embodiment, the box body 1 is assembled from six flat plates and has a rectangular-solid structure. In order to facilitate the filling of the dental floss picks 4, the flat plates are detachably connected to each other, forming an openable and closable opening.

### Thirteenth Embodiment

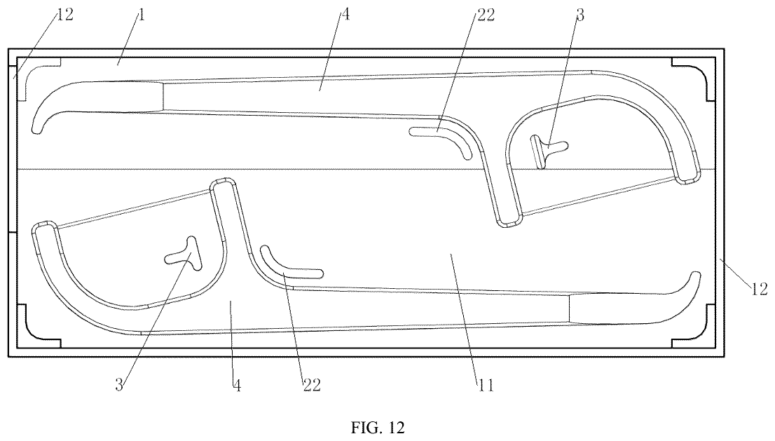

Referring to FIG. 12, the thirteenth embodiment includes the first embodiment, which differs from the first embodiment in the following aspects.

In this embodiment, preferably, there are at least two openings 12, at least two guiding structures 2, and at least two first interception structures 3. One of the openings 12 corresponds to one of the guiding structures 2 and one of the first interception structures 3. The slide-out path of the dental floss picks 4 is defined as a first direction, and the extension direction of the guiding structure 2 is defined as a second direction. Two of the openings 12 are respectively located at two opposite sides of the box body 1 in the first direction and at two opposite sides of the box body 1 in the second direction. In this way, in the thirteenth embodiment, two of the openings 12 are symmetrically arranged about a center point of the box body 1. The dental floss picks 4 in the same storage chamber 11 can slide out along different openings 12, making more efficient use of the space in the storage chamber 11. In addition, the dental floss picks 4 can be taken out from different directions of the box body 1, further improving the user experience.

In the present disclosure, all the embodiments encompass the following alternative solutions. That is, thee guiding structure 2 is formed by a wall of the storage chamber 11, and optimally, the projection of the storage chamber 11 forms the structure of the dental floss pick 4, without the need for the first guiding rod 21, the second guiding rod 22, and the third guiding rod 23. However, preferably, in order to facilitate industrial production and meet the operational space requirements of the production line equipment, the storage chamber 11 is designed as a rectangular-solid structure.

In the description of this specification, the description with reference to the terms such as “one embodiment”, “some embodiments”, “an example”, “a specific example”, or “some examples” means that the specific features, structures, materials, or characteristics described with reference to the embodiment or example are included in at least one embodiment or example of present disclosure. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without mutual contradiction.

In addition, the terms such as “first” and “second” are used only for descriptive purposes, and should not be construed as indicating or implying relative importance or implying the number of indicated technical features. Therefore, features defined by “first” and “second” may explicitly or implicitly include at least one of the features. In the description of the present disclosure, “a plurality of” means two or more, unless otherwise specifically defined.

The above merely describes specific implementations of the present disclosure, but the protection scope of the present disclosure is not limited thereto. Any person skilled in the art can easily conceive modifications or replacements within the technical scope of the present disclosure, and these modifications or replacements shall fall within the protection scope of the present disclosure. Therefore, the protection scope of the present disclosure shall be subject to the protection scope of the claims.

1. A dental floss pick storage box, comprising a box body, a guiding structure, and a first interception structure, wherein
the box body is provided with a storage chamber; the storage chamber is configured to store a plurality of dental floss picks; the box body is provided with an opening communicated with the storage chamber; and the opening is configured to allow the plurality of dental floss picks to slide out of the storage chamber;
the guiding structure is connected to the box body; the guiding structure is configured to arrange the plurality of dental floss picks in sequence along an extension direction of the guiding structure; the guiding structure is spaced apart from a side of the box body to form a first avoidance gap; and the first avoidance gap is configured to release the plurality of dental floss picks from a constraint of the guiding structure;
the first interception structure is located on a slide-out path of the plurality of dental floss picks, and is movable relative to the box body to release the plurality of dental floss picks intercepted by the first interception structure; and
when a dental floss pick of the plurality of dental floss picks is taken out from the storage chamber, the dental floss pick slides relative to the box body due to gravity and approaches the opening until the dental floss pick is supported by the first interception structure, and a part of the dental floss pick reaches out of the storage chamber along the opening.

2. The dental floss pick storage box according to claim 1, wherein the guiding structure comprises a first guiding rod; the first guiding rod is connected to the box body; the first guiding rod is spaced apart from the side of the box body to form the first avoidance gap; the first avoidance gap is configured to release the plurality of dental floss picks from a constraint of the first guiding rod; the first interception structure is connected to an end of the first guiding rod or the side of the box body, and blocks the first avoidance gap under an action of an elastic restoring force of the first interception structure.

3. The dental floss pick storage box according to claim 2, wherein the end of the first guiding rod adjacent to the first interception structure is provided with a first sliding section; the first sliding section is configured to guide and avoid the dental floss pick, such that the dental floss pick slides relative to the box body due to gravity and approaches the opening.

4. The dental floss pick storage box according to claim 1, wherein the guiding structure comprises a first guiding rod; the first guiding rod is connected to the box body; the first guiding rod is spaced apart from the side of the box body to form the first avoidance gap; the first avoidance gap is configured to release the plurality of dental floss picks from a constraint of the first guiding rod; the first interception structure is connected to an end of the first guiding rod or the side of the box body, and extends towards the opening; the first interception structure comprises a first avoidance section and a first blocking section connected to the first avoidance section; the first blocking section is closer to the opening than the first avoidance section; and when the dental floss pick is taken out from the storage chamber, the dental floss pick slides relative to the box body due to gravity and approaches the opening until the dental floss pick is supported by the first blocking section of the first interception structure.

5. The dental floss pick storage box according to claim 2, wherein the first interception structure is connected to the side of the box body, and the side of the box body is defined as an enclosing side;
the enclosing side is further connected to a padding layer; and the padding layer is configured to prevent the plurality of dental floss picks from contacting the enclosing side.

6. The dental floss pick storage box according to claim 2, wherein the guiding structure further comprises a second guiding rod; the second guiding rod is connected to the box body; the second guiding rod is spaced apart from the side of the box body to form a second avoidance gap; and the second avoidance gap is configured to release the plurality of dental floss picks from a constraint of the second guiding rod; and
the second avoidance gap is located between the first avoidance gap and the opening; and alternatively, the first avoidance gap is located between the second avoidance gap and the opening.

7. The dental floss pick storage box according to claim 6, wherein the first guiding rod is spaced apart from the second guiding rod, and at least one of the first guiding rod and the second guiding rod is nested inside a closed loop of the dental floss pick.

8. The dental floss pick storage box according to claim 2, wherein the guiding structure further comprises a third guiding rod; the third guiding rod is connected to the box body; the third guiding rod is spaced apart from the side of the box body to form a third avoidance gap; the third avoidance gap is configured to release the plurality of dental floss picks from a constraint of the third guiding rod; the dental floss pick storage box further comprises a second interception structure; the second interception structure is located on the slide-out path of the plurality of dental floss picks, and is movable relative to the box body to release the plurality of dental floss picks intercepted by the second interception structure; and
the third avoidance gap is located between the first avoidance gap and the opening.

9. The dental floss pick storage box according to claim 8, wherein the second interception structure is connected to an end of the third guiding rod or the side of the box body, and blocks the third avoidance gap under an action of an elastic restoring force of the second interception structure.

10. The dental floss pick storage box according to claim 9, wherein the end of the third guiding rod adjacent to the second interception structure is provided with a second sliding section; the second sliding section is configured to guide and avoid the dental floss pick, such that the dental floss pick slides relative to the box body due to gravity and approaches the opening.

11. The dental floss pick storage box according to claim 8, wherein the second interception structure is connected to an end of the third guiding rod or the side of the box body, and extends towards the opening; the second interception structure comprises a second avoidance section and a second blocking section connected to the second avoidance section; the second blocking section is closer to the opening than the second avoidance section; and when the dental floss pick is taken out from the storage chamber, the dental floss pick slides relative to the box body due to gravity and approaches the opening until the dental floss pick is supported by the second blocking section of the second interception structure.

12. The dental floss pick storage box according to claim 1, further comprising a limit plate; wherein the limit plate is located between the first avoidance gap and the opening; and the side of the box body is spaced apart from the limit plate to form the slide-out path for guiding and limiting the plurality of dental floss picks.

13. The dental floss pick storage box according to claim 6, wherein the first guiding rod is located inside the storage chamber, and/or the second guiding rod is located inside the storage chamber.

14. The dental floss pick storage box according to claim 1, wherein a sealing cover is connected at the opening of the box body; the sealing cover is hinged to the box body; the sealing cover is provided with a first clamping groove and a second clamping groove; when the opening is in an opened state, the first clamping groove cooperates with the box body; and when the opening is in a closed state, the second clamping groove cooperates with the box body.

15. The dental floss pick storage box according to claim 14, wherein the box body is provided with a clamping portion; and the first clamping groove and the second clamping groove are allowed to be clamped to the clamping portion.

16. The dental floss pick storage box according to claim 1, wherein the box body comprises a first constituent part and a second constituent part detachably connected to the first constituent part; the storage chamber is located in the first constituent part and covered by the second constituent part; and at least one of the guiding structure and the first interception structure is located at the second constituent part.

17. The dental floss pick storage box according to claim 16, wherein a plurality of anti-deformation reinforcement connection elements are connected between the first constituent part and the second constituent part.

18. The dental floss pick storage box according to claim 1, wherein the box body comprises a filling portion and a filling cover hinged to the filling portion; the filling cover is located at a side in the extension direction of the guiding structure; and the storage chamber is located in the filling portion and covered by the filling cover.

19. The dental floss pick storage box according to claim 1, wherein there are at least two openings, at least two guiding structures, and at least two first interception structures; one of the at least two openings corresponds to one of the at least two guiding structures and one of the at least two first interception structures; the slide-out path of the plurality of dental floss picks is defined as a first direction, and the extension direction of the guiding structure is defined as a second direction; and two openings of the at least two openings are respectively located at two opposite sides of the box body in the first direction and at two opposite sides of the box body in the second direction.

20. A dental floss dispenser for easy take-out of a plurality of dental floss picks, comprising the plurality of dental floss picks and the dental floss pick storage box according to claim 1, wherein the plurality of dental floss picks are stored in the storage chamber and arranged in sequence in a stacked manner along the extension direction of the guiding structure; and a tip of the dental floss pick is closer to the opening than a closed loop of the dental floss pick.
